(19) United States
(12) Patent Application Publication
(10) Pub. No.: US 2023/0236097 A1
(43) Pub. Date: Jul. 27, 2023

(54) PACKAGING TESTING DEVICE

(71) Applicant: H.B. Fuller Company, St. Paul, MN (US)

(72) Inventor: James E. Welton, Coon Rapids, MN (US)

(21) Appl. No.: 18/002,628

(22) PCT Filed: Jun. 21, 2021
(86) PCT No.: PCT/US2021/070736

§ 371 Date: Dec. 20, 2022

Related U.S. Application Data
(60) Provisional application No. 63/042,265, filed on Jun. 22, 2020.

(51) Int. Cl. G01N 3/08; G01N 3/30

(52) U.S. Cl. CPC G01N 3/08; G01N 3/30; G01N 2203/0037

(57) ABSTRACT

A testing device including a base having a first joint and an arm. The arm has a first branch connected to and pivotable about the first joint, a second joint connected to the first branch, a second branch connected to and pivotable about the second joint, a third joint connected to the second branch, and a third branch connected to and pivotable about the third joint. The third branch can have an attachment mechanism. The first joint is configured to drive movement of the arm through rotation of the first joint.

### FIELD

This disclosure relates to a packaging testing device and a use of the testing device. In particular, this disclosure relates to a device for testing a packaged assembly.

### BACKGROUND

Packaging configurations for consumer items include designs that enclose or carry the items to be packaged. Often the packaging is in the form of a box or carton. A box for packaging multiple items such as cans, bottles, or cartons of food or beverages often incudes enough packaging material that the box can encase the packaged items and may also include a top that can be closed to completely enclose the items.

It is sometimes desired to reduce the amount of material used for packaging. An example of a packaging configuration that can have less material than a box may be a bottle carrier having an open top with individual openings for receiving each item. Some bottle carriers have multiple separate openings, often about four or six, with one opening for each bottle. Such carriers often have an open top and each bottle can be lifted out of the carrier without having to first separate a section of the carrier, such as opening a top flap of a box, or tearing apart an end portion of the box when opening cardboard boxes typically used for containing cans.

Another example of packaging is a ring holder. One example of a ring holder is a beverage container such as those commercially available under the tradenames RINGCYCLES and HI-CONE (of ITW, located in Itasca, Ill., USA), including plastic six-pack rings, for example. In general, such packaging configuration includes a set of openings defined in a holder, with each opening shaped to retain an individual item such as a can or bottle. This packaging configuration can be shaped to retain the item, such as an individual beverage container, at a specific location on the item such as the top or middle portion of a can or bottle. A consumer can separate one item from the remaining items of the packaging configuration and the packaging material itself by pulling the item through the opening of the packaging or breaking the portion of the packaging that is retaining the item. Often such packaging is made from plastic or cardboard material.

Alternative packaging configurations are continually being developed. Some desired characteristics of alternative packaging configurations include eliminating or reducing the use of plastics in the packaging material. There is a need for a testing device to measure the performance characteristics of such alternative packaging configurations.

### SUMMARY

Disclosed herein is a testing device including a base and an arm. The arm includes a first branch pivotally connected with the base, a second branch freely pivotally connected with the first branch, and a third branch freely pivotally connected with the second branch and including an attachment device. The base includes a driving mechanism configured to rotate the first branch. The second joint and third joint are configured to rotate freely. Disclosed herein is a testing device including a base including a first joint, and an arm. The arm has a first branch connected to and pivotable about the first joint, a second joint connected to the first branch, a second branch connected to and pivotable about the second joint, a third joint connected to the second branch, and a third branch connected to and pivotable about the third joint. The third branch can include an attachment mechanism. The arm is configured to pivot at the first joint in relation to the base along an X-Z plane. The first joint is configured to drive movement of the arm through rotation of the first joint.

In some aspects, the first joint is configured to control movement of the arm along the X-Z plane through rotation about the first joint. In some aspects, the test device includes a motor configured to drive rotation of the first joint. In some aspects, the test device includes a motor configured to control movement of the arm along the X-Z plane through rotation of the first joint. In some aspects, the second branch is configured to rotate about the second joint in an orientation parallel to the X-Z plane. In some aspects, the third branch is configured to rotate about the third joint in an orientation parallel to the X-Z plane. In some aspects, the first branch has a first end and a second end, the second joint being connected to the second end of the first branch; the second branch has a first end and a second end, the third joint being connected to the second end of the second branch; and the third branch has a first end and a second end, and the attachment mechanism is connected to the second end of the third branch.

In some aspects, the first joint is attached to a slide that is movable from a first end of the base to a second end of the base. In some aspects, the attachment mechanism is configured to retain a first portion of a test sample. In some aspects, the arm includes a stress measurement device. In some aspects, the testing device further includes at least one selected from the group of a load cell, a strain gauge, a transistor, a transducer, and a position indicator. In some aspects, the testing device further includes a motion capture device. In some aspects, the arm further includes passive markers. In some aspects, the testing device further includes a speed analysis device. In some aspects, the testing device further includes a retention device associated with the base. In some aspects, the testing device further includes a retention device associated with and positioned a fixed distance from the base. In some aspects, the testing device further includes a retention device associated with and configured to retain a second portion of a test sample at a fixed distance from the base.

Disclosed herein is a testing device having a base defining a first end and a second end and a length defined along a direction perpendicular to an X-Y plane. The base has a first joint pivotable in an orientation parallel to an X-Z plane and an arm. The arm includes a first branch having a first end and a second end, the first branch connected to and pivotable about the first joint in an orientation parallel to the X-Z plane, a second joint connected to the first branch, a second branch having a first end and a second end, the second branch connected to and pivotable about the second joint in an orientation parallel to the X-Z plane, a third joint connected to the second branch; and a third branch having a first end and a second end. The third branch is connected to and pivotable about the third joint in an orientation parallel to the X-Z plane, and the second end of the third branch defines an attachment mechanism. The first joint is configured to drive movement of the arm.

In some aspects, the second joint and third joint are configured to rotate freely. In some aspects, the first joint is configured to control movement of the arm along the X-Z plane direction through rotation of the first joint. In some aspects, the testing device further includes a motor configured to the drive rotation of the first joint. In some aspects, the attachment mechanism is configured to attach to a first portion of a test sample. In some aspects, the first joint is attached to a slide that is movable from a first end of the base to a second end of the base. In some aspects, the testing device further includes a retention device configured to be positioned a fixed distance from the base. In some aspects, the testing device further includes a retention device configured to retain a second portion of a test sample at a fixed distance from the base. In some aspects, the testing device further includes at least one selected from the group of a load cell, a strain gauge, a transistor, a transducer, and a position indicator. In some aspects, the testing device further includes a motion capture device. In some aspects, the arm further includes passive markers. In some aspects, the testing device further includes a speed analysis device.

Disclosed herein is testing device having a base that extends perpendicular to an X-Y plane, and an arm. The arm includes a first branch connected to the base, a means for driving rotation of the first branch in an orientation that is parallel to the X-Z plane, a second branch in connection with the first branch, a means for rotating the second branch in an orientation that is parallel to the X-Z plane, a third branch connected to the second branch, a means for rotating the third branch in an orientation that is parallel to the X-Z plane. and an attachment device connected to the third branch. The attachment mechanism can be configured to retain a test sample.

In some aspects, the arm is configured to be movable by rotation of the first joint, and the second joint and third joint are configured to rotate freely. In some aspects, the first joint is configured to drive movement of the arm along the X-Z plane through rotation of the first joint. In some aspects, the testing device further includes a motor configured to drive rotation of the first joint along the X-Z plane. In some aspects, the means for rotating the second branch and the means for rotating the third branch are configured to freely rotate. In some aspects, the testing device further includes a retention device configured to be positioned a fixed distance from the base. In some aspects, the testing device further includes a retention device configured to retain a second portion of a test sample at a fixed distance from the base. In some aspects, the testing device further includes a slide that is movable from a first end of the base to a second end of the base, the first joint being attached to the slide. In some aspects, the testing device further includes at least one of a load cell, a strain gauge, a transistor, a transducer, and a position indicator. In some aspects, the testing device further includes a motion capture device. In some aspects, the arm further includes passive markers. In some aspects, the testing device further includes a speed analysis device.

Disclosed herein is a testing method including rotating a first joint of a test apparatus along an X-Z plane. The first joint is connected to an arm including a first branch having a first end and a second end, the first branch being connected to the first joint and pivotable about the first joint in an orientation that is parallel to the X-Z plane; a second joint connected to the first branch; a second branch connected to and pivotable about the second joint parallel to the X-Z plane; a third joint connected to the second branch; a third branch connected to and pivotable about the third joint in an orientation that is parallel to the X-Z plane, and an attachment mechanism configured to retain a first portion of a test subject. The method includes separating the first portion of the test subject from a second portion of the test subject.

In some aspects, the first branch has a first end and a second end, the second joint being connected to the second end of the first branch; the second branch having a first end and a second end, the third joint being connected to the second end of the second branch; and the third branch has a first end and a second end. In some aspects, the attachment mechanism is connected to the second end of the third branch. In some aspects, the movement of the arm is driven by rotation of the first joint. In some aspects, the method further includes controlling movement of the arm along the X-Z plane through rotation of the first joint. In some aspects, the method further includes retaining the second portion of the test subject a fixed distance from the first joint.

In some aspects, the arm includes passive markers. In some aspects, the arm further includes at least one of a load cell, a strain gauge, a transistor, a transducer, and a position indicator. In some aspects, the method further includes recording motion of the arm with a motion capture device. In some aspects, the method further includes recording motion of the arm with an analysis device. In some aspects, the method further includes measuring the stress exerted on the arm in relation to the distance of the attachment mechanism from the second portion of the test subject. In some aspects, the method further includes measuring the stress exerted on the arm in relation to a position of the attachment mechanism. In some aspects, the first portion of the test subject is any of a can, bottle, or box. In some aspects, the test subject is a plurality of cans, bottles, or boxes, and the first portion of the test subject is a can, a bottle, or a box of the test subject.

The disclosed embodiments are intended to be within the scope of the invention described herein. These and other embodiments of the present invention will become readily apparent to those skilled in the art from the following detailed description of the various embodiments having reference to the attached figures, the invention not being limited to any particularly preferred embodiment(s) disclosed.

### GLOSSARY

As used herein, the X-direction is the direction extending left and right of a viewer as viewed from a front view of an image.

As used herein, the Y-direction is the direction extending toward and away from a viewer as viewed from a front view of an image.

As used herein, the Z-direction is the direction defined by a line extending up and down of a viewer looking at a front view of an image.

As used herein, the term “translational motion” is the motion by which a body shifts from one point in space to another.

As used herein, the term, “linear motion” is movement of an object along a line parallel to a prescribed 2-dimensional plane.

As used herein, the term “circular motion” is movement of an object along a curved line.

As used herein, the term “rotational motion” is movement of an object such that the object changes its orientation with respect to a point external to the object.

### BRIEF DESCRIPTION OF THE DRAWINGS

FIG. 1 is front view of a testing system, in accordance with certain embodiments.

FIG. 2 is a front perspective view of a testing system, in accordance with certain embodiments.

FIG. 3 is front view of a testing device, in accordance with certain embodiments.

FIG. 4A is an example of an attachment mechanism, in accordance with certain embodiments.

FIG. 4B is an example of an attachment mechanism, in accordance with certain embodiments.

FIG. 4C is an example of an attachment mechanism, in accordance with certain embodiments.

FIG. 4D is an example of an attachment mechanism, in accordance with certain embodiments.

FIG. 4E is an example of an attachment mechanism, in accordance with certain embodiments.

FIG. 4F is an example of an attachment mechanism, in accordance with certain embodiments.

FIG. 5 is a front perspective view of a testing system, in accordance with certain embodiments.

FIGS. 5A to 5C are expanded views of various components that can be included with the testing system of FIG. 5, in accordance with certain embodiments.

FIG. 6 is a front view of a retention device, in accordance with certain embodiments.

FIGS. 7A and 7B are front perspective views of testing systems, in accordance with certain embodiments.

FIGS. 8A to 8F are front views of a testing system at progressive stages in a testing sequence, in accordance with certain embodiments.

FIG. 9 is a front perspective view of a testing system and an example packaging configuration, in accordance with certain embodiments.

FIG. 10 is a front perspective view of a testing system and an example packaging configuration, in accordance with certain embodiments.

FIG. 11 is a front perspective view of a testing system and an example packaging configuration, in accordance with certain embodiments.

FIG. 12 is a front perspective view of a testing system and an example packaging configuration, in accordance with certain embodiments.

FIG. 13 is a front perspective view of a testing system and an example packaging configuration, in accordance with certain embodiments.

FIG. 14 is a front perspective view of a testing system and an example packaging configuration, in accordance with certain embodiments.

FIG. 15A is a front perspective view of a testing system and an example packaging configuration, in accordance with certain embodiments.

FIG. 15B is a schematic expanded view of the inset from FIG. 15A shown by the arrow A, in accordance with certain embodiments.

FIG. 15C is a front perspective view of the testing system and example packaging configuration shown in FIG. 15A, in accordance with certain embodiments.

FIG. 16 shows a plot of force versus time experienced by a test sample, in accordance with certain embodiments.

FIG. 17 shows a plot of force versus time experienced by a test sample, in accordance with certain embodiments.

FIG. 18 shows a plot of force versus time experienced by a test sample, in accordance with certain embodiments.

FIG. 19 shows a plot of force versus time experienced by a test sample, in accordance with certain embodiments.

FIG. 20 shows a plot of force versus time for certain test samples, in accordance with certain embodiments.

FIG. 21 shows bar graphs of peak impulse versus time for certain test samples, in accordance with certain embodiments.

FIG. 22 shows a plot of force versus time experienced by a test sample, in accordance with certain embodiments.

FIG. 23 shows a plot of force versus time experienced by a test sample, in accordance with certain embodiments.

FIG. 24 shows a plot of force versus time experienced by a test sample, in accordance with certain embodiments.

FIG. 25 shows a plot of impulse versus rotation experienced by a test sample, in accordance with certain embodiments.

FIG. 26 shows a plot of impulse versus rotation experienced by a test sample, in accordance with certain embodiments.

FIG. 27 shows a plot of impulse versus rotation experienced by a test sample, in accordance with certain embodiments.

### DETAILED DESCRIPTION

Disclosed herein is a testing device suitable for measuring the performance characteristics of a packaging configuration. in some embodiments, the testing device includes a multijointed apparatus that includes a first joint that can be driven with a motor, and additional joints that can freely pivot. The testing device can be a multijointed apparatus that can carry an object through at least one motion (e.g. linear, curvilinear, circular, parabolic, elliptical, and rotational motion) while measuring forces exerted against or by the object. The testing device can represent motions that the item experiences that more closely represents the motions consumer might separate a first item from a packaged assembly relative to a device that can only measure forces applied in the item in a linear direction.

The testing device can measure the forces that are applied to items of a packaged assembly when an item is separated from the packaged assembly. This test mimics the forces experienced by a packaged assembly when a user removes the item from the packaged assembly. The testing device can be used to measure the failure mode of a packaging configuration that holds multiple items together as a packaged assembly. The testing device can provide a more accurate representation of how a packaging configuration (which includes features such as the kind of packaging material, the amount of packaging material, the packaging shape, and the location of the packaging material in relation to the packaged items) performs when items are separated from the packaged assembly relative to a test that is conducted over a limited. range of motion, for example, a test that only uses a linear separation motion.

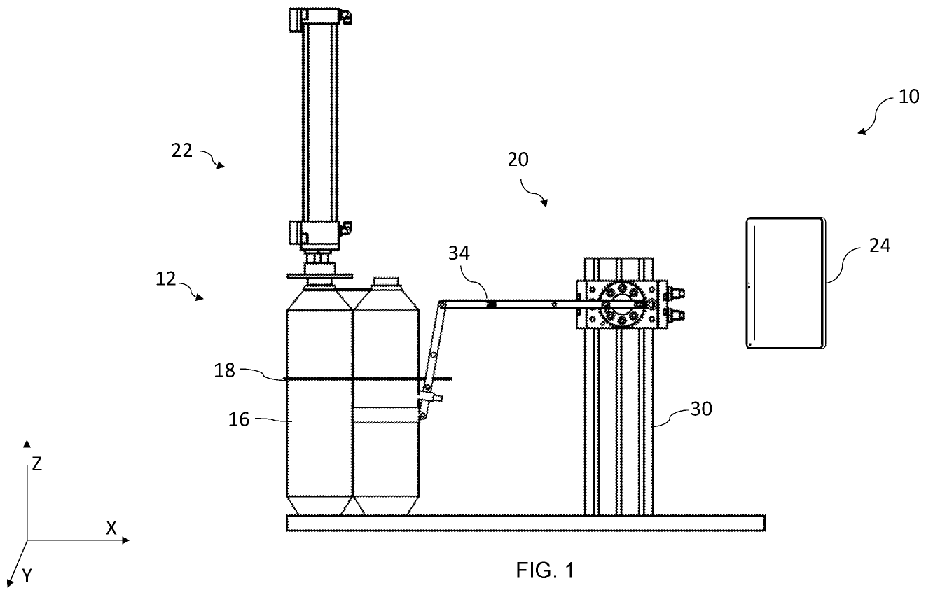

FIG. 1 shows a front view of a testing system 10 shown with an example packaged assembly 12. With reference to FIG. 1, the testing system 10 includes a testing device 20, having a base 30, and an arm 34. In some embodiments, the testing system 10 includes a retention device 22. As shown, the testing system 10 can include additional components, such as a control panel 24, and/or a frame or case (not shown) for containing the testing system 10. The packaged assembly 12 shown in FIG. 1 includes a plurality of items 16 held together through a packaging configuration 18. The retention device 22 can be positioned a fixed distance from the base 30. The retention device 22 can be positioned a suitable distance from the base 20 such that the retention device 22 can retain a first portion of the packaged assembly 12 and the arm 34 can extend from the base 20 to a second portion of the packaged assembly 12.

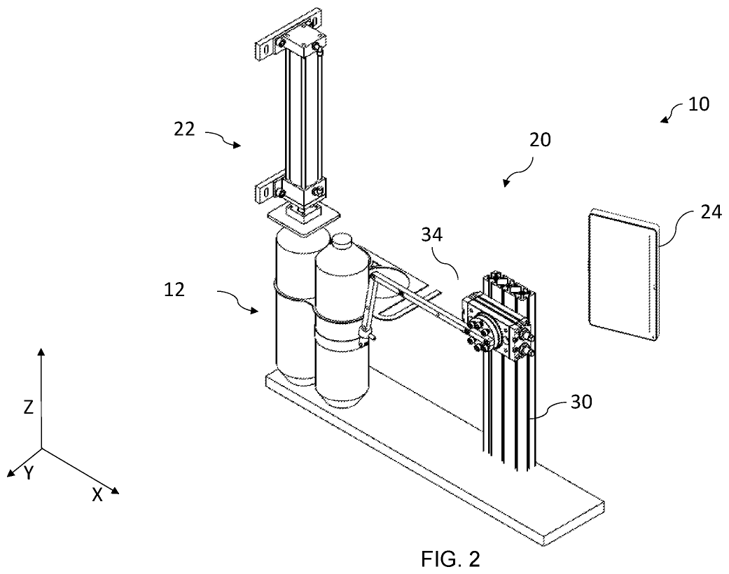

FIG. 2 shows a front perspective of the testing system shown in FIG. 1, to illustrate the components of FIG. 1 from another angle. FIG. 2 shows the testing system 10, packaged assembly 12, testing device 20, retention device 22, control panel 24, base 30, and arm 34.

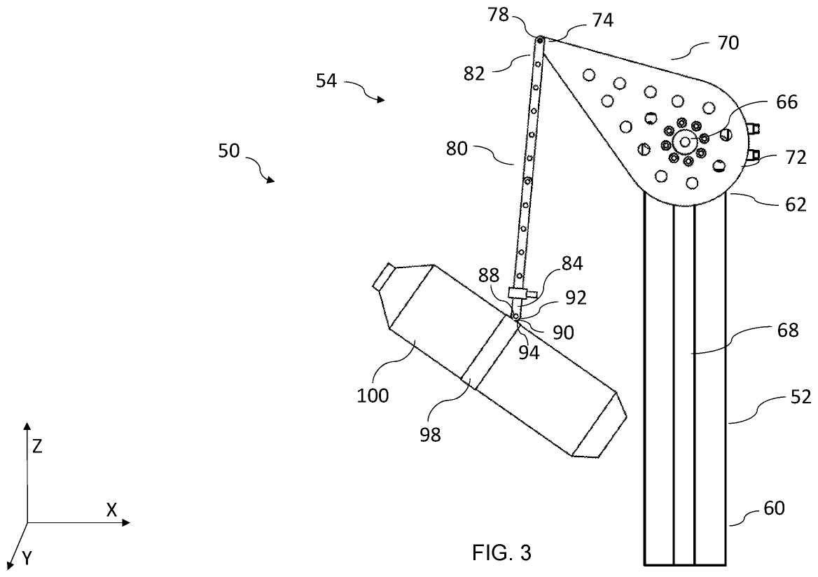

FIG. 3 shows a front view of a testing device 50, having a base 52, and an arm 54, in accordance with some embodiments. The base 52 defines a first end 60, a second end 62, and a length extending in between. The base 52 includes a first joint 66, and an optional slide 68. The arm 54 includes a first branch 70, second joint 78, second branch 80, third joint 88, third branch 90, and an attachment mechanism 98. The first branch 70 defines a first end 72, a second end 74, and a length extending between. The second branch 80 defines a first end 82, a second end 84, and a length extending between. The third branch 90 defines a first end 92, a second end 94, and a length extending between. The third branch 90 includes an attachment mechanism 98. FIG. 3 shows the attachment mechanism 98 with a test sample 100. As shown, the arm 54 can be pivotally connected to the base 52 with the first joint 66.

As shown in FIG. 3, the first end 60 of the base 52 corresponds to the bottom portion of the base 52 and is suitable for positioning on a surface, for example, defined along an X-Y plane. As shown, the second end 62 of the base 52 corresponds to the top portion of the base 52, and the length of the base 52 extends in a direction perpendicular to the X-Y plane. Although shown in FIG. 3 with the length of the base extending perpendicular to the X-Y, as in an upright position, the testing device 50 can be operated with the base 52 oriented in any suitable position. For example, the testing device 50 may be operated with the base 52 positioned along an alternative orientation, such as if a test is to be operated from a different angle relative to a packaging configuration.

As shown, the base 52 includes the first joint 66. The first joint 66 can be any suitable device that allows objects to be connected and turn in relation to one another. For example, the first joint can be any suitable device that allows two components to turn, pivot, spin, revolve, rotate, or swing in relation to one another. Some examples of a mechanism that the first joint 66 can include may be any of a swivel, hinge, hub, gudgeon, trunnion, or ball and socket joint.

The first joint 66 is connected to the base 52 and is configured to rotate. The first joint 66 can be pivotally connected to the base 52 and can rotate with respect to the base 52. In some embodiments, the first joint 66 can rotate in a direction parallel to the length of the base 52. For instance, the first joint 66 can be a joint with an axis perpendicular to the length of the base 52. The first joint 66 can be a joint that rotates along a plane parallel to the plane that the length of the base 52 is oriented. In some embodiments, the first joint 66 can rotate in three dimensions. For example, the first joint can be a ball and socket joint that can rotate both parallel to and perpendicular to the length of the base 52.

In some embodiments, the base 52 includes the slide 68 which can be adjusted to a position along the length of the base 52. In some embodiments, the slide 68 may be any suitable linear actuator such as an electric, mechanical, hydraulic, pneumatic, or combination thereof. The first joint 66 can be attached to the slide 68. For example, the first joint 66 can be attached to the slide 68 and the slide 68 can be positioned a suitable distance along the length of the base 52. The slide 68 can be positioned with the first joint 66 a suitable height above a surface on which the base 50 is positioned. The base 52 can include any suitable mechanism for anchoring the base 52 along a surface. For example, the base 52 may include a platform for anchoring the base 52 using a bracket. Additionally, or alternatively, the base 52 may be affixed to a surface such as with the use of bolts, screws, adhesive, tape, or a hook and loop system, such that the base 52 remains in a fixed location along the surface.

The first branch 70 defines a first end 72, a second end 74, and a length extending between. In general, the length and the width of the first branch 70 are defined along the X-Z plane, and a thickness is defined along the X-Y plane or into the direction of the front view. The first branch 70 is connected to the first joint 66. The first branch 70 can be connected to the first joint 66 at a position proximate the first end 72, for example, at suitable location along the length of the first branch 70 between the middle and the first end 72.

The first branch 70 can rotate about the first joint 66, for example, about an axis defined by the first joint 66. For instance, the first branch 70 can rotate around an axis perpendicular to the length of the base 52. The first branch 70 can rotate in a plane parallel to the plane that the length of the base 52 is oriented, for example along the X-Z plane. In some examples, the first branch 70 can rotate parallel to and perpendicular to the length of the base 52, for example, if the first joint 66 is a ball and socket joint.

The first joint 66 can control movement of the first branch 70 through rotation of the first joint 66. For example, the first joint 66 can drive movement of the first branch 70 along the X-Z plane through rotation of the first joint 66. The first joint 66 can be driven by a motor (not shown), for example, attached to the base 52. In some embodiments, rotation of the first joint can be driven by any suitable configuration such as a motor or a counterweight. In some embodiments, rotation of the first joint can be driven by any suitably powered device such as an electric driven motor, an engine, a magnetic drive system, or a weighted pulley system. In some embodiments, rotation of the first joint can be driven by a motor such as a servo motor. In some embodiments, rotation in a suitable direction can be driven by rotating the first joint 66 with a motor that can be controlled to provide a suitable amount of force such that the arm 54 can lift the test sample 100.

As shown, the second joint 78 is connected to the first branch 70 and the second branch. The second joint 78 can be connected to the first branch 70 at a position proximate the second end 74, for example, at suitable location along the length of the first branch 70 between the middle and the second end 74.

The second branch 80 can be pivotally connected to the first branch 70 with the second joint 78. In some embodiments, the second branch 80 can be freely pivotally connected to the first branch 70. That is, the second branch 80 can be connected to the first branch 70 through a joint that is free of a drive mechanism such that the second branch 80 can freely pivot relative to the first branch 70 in response to movement of any of the first or second branch 70, 80. As shown in FIG. 3, the second branch 80 defines a first end 82, a second end 84, and a length extending between. The second branch 80 is connected to the second joint 78. The second branch 80 can be connected to the second joint 78 at a position proximate the first end 82; for example, at suitable location along the length of the second branch 80 between the middle and the first end 82.

The second branch 80 can rotate about the second joint 78, for example, about an axis defined by the second joint 78. For instance, the second branch 80 can rotate around an axis perpendicular to the length of the base 52. In some instances, the second branch 80 can rotate about an axis perpendicular to the length of the first branch 70. The second branch 80 can rotate in a plane parallel to the plane that the length of the base 52 is oriented, for example along the X-Z plane. In some examples, the second branch 80 can follow a path that sweeps both parallel to and perpendicular to the length of the first branch 70, for example, if the second joint 78 is a ball and socket joint. In some embodiments, the second joint 78 can freely pivot. That is, the second joint 78 can be free of a powered driving mechanism. In some embodiments, a drive mechanism can be included to drive rotation of the second joint 78. For example, a motor, such as a servo motor, can be included for any of a variety of functions including e.g. determining location, increasing the accuracy of positional data, receiving force feedback, or introducing an additional path to the movement of a test sample.

As shown, the third joint 88 is connected to the second branch 80. The third joint 88 can be connected to the second branch 80 at a position proximate the second end 84; for example, at suitable location along the length of the second branch 80 between the middle and the second end 84.

The third branch 90 can be pivotally connected to the second branch 80 through the third joint 88. In some embodiments, the third branch 90 can be freely pivotally connected to the second branch 80. That is, the third branch 90 can be connected to the second branch 80 through a joint that is free of a drive mechanism such that the third branch 90 can freely pivot relative to the second branch 80 in response to movement of any of the second or third branch 80, 90. As shown, the third branch 90 defines a first end 92, a second end 94, and a length extends between. The third branch 90 is connected to the third joint 88. The third branch 90 can be connected to the third joint 88 at a position proximate the first end 92; for example, at suitable location along the length of the third branch 90 between the middle and the first end 92.

The third branch 90 can rotate about the third joint 88, for example, about an axis defined by the third joint 88. The third branch 90 can rotate around an axis perpendicular to the length of the base 52. In some instances, the third branch 90 can rotate around an axis perpendicular to the length of any of the first branch 70 or second branch 80. The third branch 90 can rotate along a plane parallel to the plane that the length of the base 52 is oriented in, for example along the X-Z plane. In some examples, the third branch 90 can rotate along a path that sweeps both parallel to and perpendicular to the length of the second branch 80, for example, if the third joint 88 is a ball and socket joint. In some embodiments, the third joint 88 can freely pivot. That is, the third joint 88 can be free of a powered driving mechanism. In some embodiments, a drive mechanism can be included to drive rotation of the third joint 88. For example, a motor, such as a servo motor, can be included for any of determining location, increasing the accuracy of positional data, receiving force feedback, or introducing an additional path to the movement of a test sample.

As shown, the second end of the 94 of the third branch 90 can include the attachment mechanism 98. The attachment mechanism 98 may be any suitable apparatus for retaining a test sample 100, for example retaining a portion of a packaged assembly (such as those shown in FIGS. 1 and 2). In some instances, a test sample can include multiple items, for instance, multiple items held together as a packaged assembly. In some instances, a test sample can be a single item such as a box, carton, tube, jug, can, or bottle.

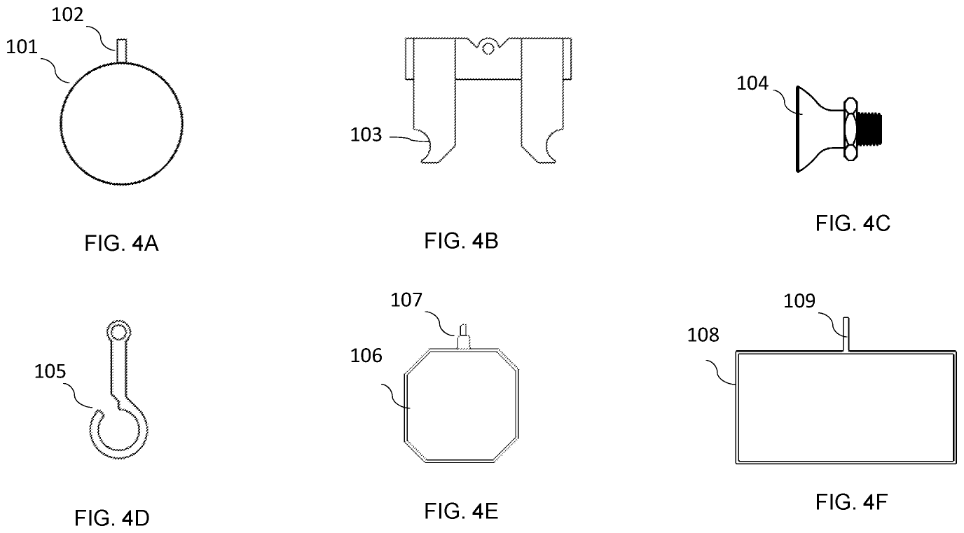

FIGS. 4A to 4F show various example devices suitable as the attachment mechanism 98 shown in FIG. 3. FIG. 4A shows an example attachment mechanism that can include a ring 101 for positioning around a test sample and a connector 102 for connecting to a test device. FIG. 4B shows an example attachment mechanism that can include a clamp 103. For example, the clamp 103 can include a spreader or a gripper for holding on to a test sample by spreading a jaw mechanism to interlock with a portion of the test sample, such as a jug handle, or by pressing the sides of the test sample. FIG. 4C shows an example attachment mechanism that can include a suction cup 104 for attaching to a test sample. FIG. 4D shows an example attachment mechanism that can include a hook 105 for positioning around a portion of a test sample. FIG. 4E shows an example attachment mechanism that can include a strap 107 for positioning around a test sample and a connector 107 for connecting to the arm. The strap 107 can be flexible such that it contours to the shape of the test sample, for example to form a multisided shape, as shown. FIG. 4F shows an example attachment mechanism that can include a bracket 108 for positioning around a test sample and a connector 109 for connecting to the arm.

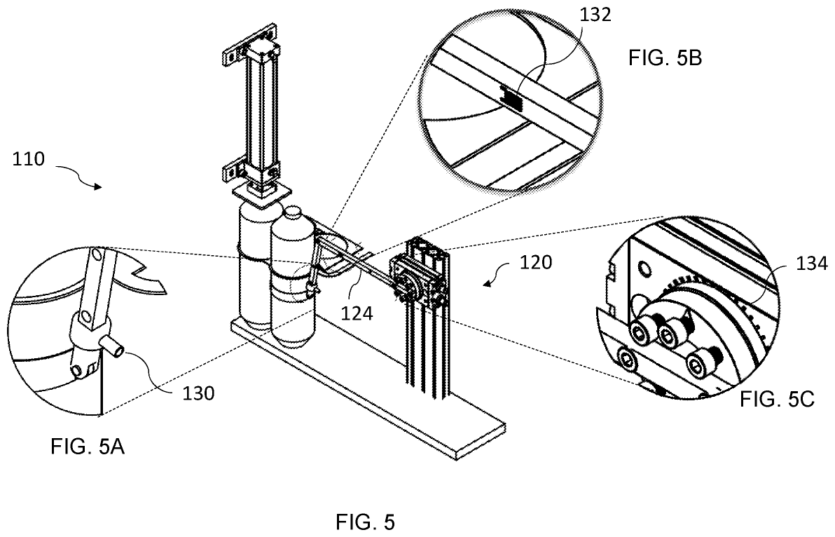

FIG. 5 shows an example testing system 110 having a base 120 and an arm 124. FIGS. 5A to 5C illustrate components of the testing system 110 in enlarged views.

FIG. 5A shows a load cell 130 that may be included. In some embodiments, the load cell 130 can be positioned on the arm 124 of the testing device 120. Generally, a load cell is a type of transducer, such as a pressure transducer, which may be hydraulic or pneumatic. The load cell can measure force, pressure, tension, or even weight. In some embodiments, the load cell 130 may be a force transducer suitable for converting a force such as tension, compression, pressure, or torque into an electrical signal that can be measured. As the force applied to the load cell 160 changes, such as the force applied by the arm 124, the electrical signal changes proportionally and can be measured and recorded. In some embodiments, the load cell 130 can be a multi axis load cell.

FIG. 5B shows an example strain gauge 132, that may be included on the arm 124 of the testing device 120. The strain gauge 132 can include a sensing element for measuring forces applied on the arm 124. For example, the strain gauge 132 can measure any of the compressive, tensile, rotational, or torsional forces. The strain gauge 132 can measure stresses applied to the arm 124, for example, by a tensile force imparted by the arm 124 acting on a test sample. As changes in force, pressure, tension, or weight are experienced by the arm 124, an electrical resistance in the strain gauge changes proportionally and can be measured and recorded. In some embodiments, a strain gauge includes a wire, or foil, set up in a grid pattern and attached to a flexible backing. When the shape of the strain gauge is altered, a change in the electrical resistance occurs. The strain gauge 132 may include a spring element included to monitor the stress in the sensing element when the spring element is subjected to a bending force. The strain gauge may be any of a single point, double ended, cannister type, S-type, tension link, button, pancake, load pin, shear beam load cell, or combination thereof. In some embodiments, the arm 124 can include two or more strain gauges.

FIG. 5C shows a position indicator 134. In some embodiments, the position indicator 134 has a first section attached to a branch, a second section connected to the center of a joint, and a graduated indicator to indicate the relative position of the two section to each other. In some embodiments, the position indicator 134 can include a rotary encoder that indicates the position of an object, such as the arm 124, relative to a pivot axis. The position indicator 134 can be used to determine what position the arm 124 is in, for example what angle the arm defines with respect to a fixed position, such as the X-Y plane at a certain moment in time. The position indicator 134 can help determine at what position the arm 124 experiences certain stresses. For example, the position indicator 134 can be used to determine what stresses are applied to the arm 124 at specific positions as the arm 124 moves.

The testing system 110 can include a variety of measurement means to measure various forces including but not limited to those illustrated in FIGS. 5A to 5C. In some embodiments, the testing system 110 can include optional components such as any of a motion capture device, a measurement grid, or an accelerometer. For example, a motion capture device can include a high-speed camera operated to capture images of the testing device 110 as it moves. The measurement grid may be a ruler or grid positioned behind the testing device 110 such that the position of components of the testing device and/or a test sample can be determined at moments in time. The motion capture device can be used with a motion capture analysis tool to determine movement, such as a position versus time tracker. A motion capture device can also be used with a measurement grid to plot or track an object as is moves over a known distance in a measured amount of time. The accelerometer can be positioned at a suitable location of the testing device to measure acceleration of that portion of the testing device.

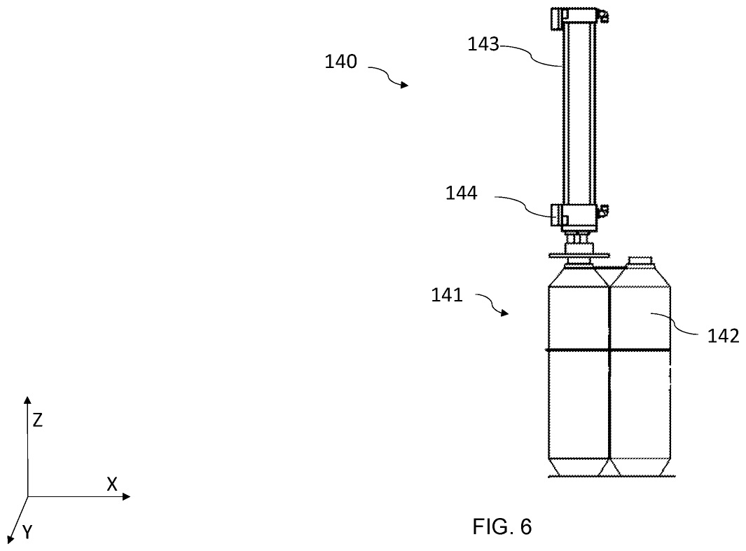

FIG. 6 shows a retention device 140, a packaged assembly 141, and a test sample 141, according to some embodiments. The retention device 140 may be included in the system 10 shown in FIGS. 1 and 2. In some embodiments, the retention device 140 may be associated with a testing device, for example, the retention device 140 may be positioned proximate to the testing device 50 described with reference to FIG. 3. As shown in FIG. 6, the test sample 142 can be an item that is part of the packaged assembly 141. The packaged assembly 141 can include a plurality of items (e.g. cans, bottles, boxes, cartons, tubes, jugs) held together with a packaging configuration.

In some embodiments, the retention device 140 includes a clamp 143 and a holder 144. The clamp 143 can move the holder 144 in relation to the packaged assembly 141. The clamp 144 may be movable from a first position, to allow the packaged assembly 141 to be placed in a suitable position relative to the holder 144, to a second position with the holder 144 in contact with the packaged assembly 141. In some embodiments, the clamp 143 can be any suitable mechanism for positioning the holder 144 to retain a first portion of the packaged assembly 141 such that if a second portion of the packaged assembly 141, such as the test sample 142 is moved, the portion of the packaged assembly 141 that is in contact with the holder 144 is retained. The clamp 143 can include any suitable actuator such as a piston, spring, or rack and gear, that applies pressure to the holder 144 such that the holder 144 retains the first portion of the packaged assembly 141. If the test sample 142 is pulled away from the first portion of the packaged assembly 141 being held by the retention device 140, the retention device 140 holds the packaged assembly 141 in place.

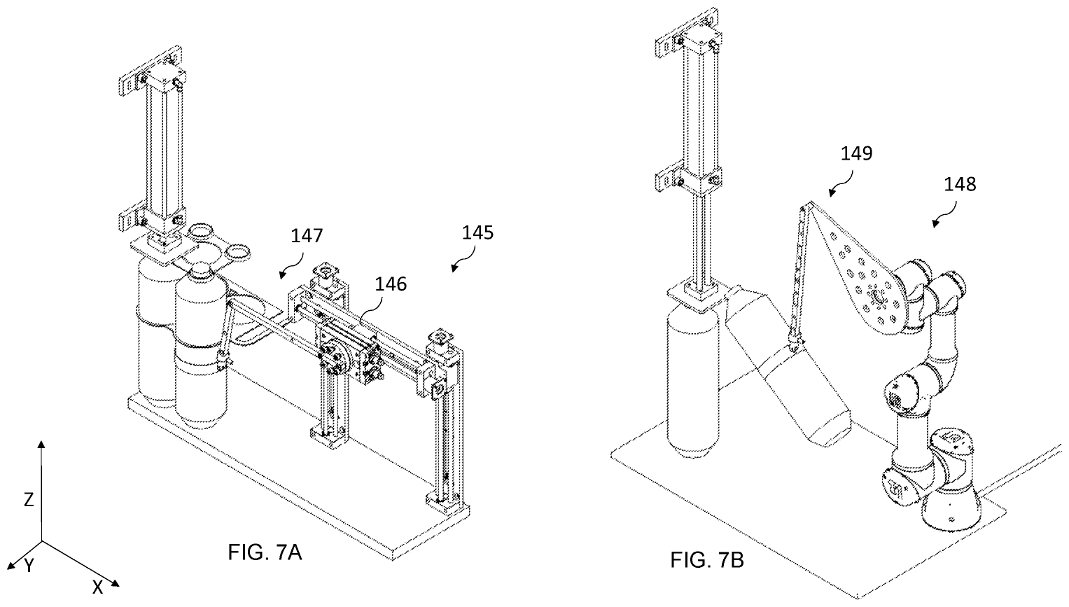

FIGS. 7A and 7B are front perspective views showing embodiments of a base that can be included with the testing systems disclosed herein. FIG. 7A shows a base 145 having a shuttle system 146. An arm 147 can be connected to the shuttle system 146. The arm 147 can be any suitable example disclosed herein, such as the arm 34 or arm 54 shown in FIG. 1 or 3. The shuttle system 146 is movable in relation to a surface that the base 145 is positioned on. For example, the shuttle system 146 can be moved such that the arm 147 is brought closer to or further away from a test sample. In some embodiments, the base 145 having the shuttle system 146 can be operated to be repositioned along various axes, for example, it can be operated to move the arm 147 in an orientation through any of the X-Y, X-Z, and Y-Z planes.

FIG. 7B shows a base 148 that has one or more joints. An arm 149 can be connected to the base 148. The arm 149 can be any suitable example disclosed herein, such as the arm 34 or arm 54 shown in FIG. 1 or 3. The base 148 can be operable to move the arm 149 in relation to a test sample. For example, the joints of the base 148 can be movable such that the arm 149 can be moved in any suitable direction in relation to a surface that the base 145 is positioned on. The base 148 can be operated such that the arm 149 is brought closer to or further away from a test sample. In some embodiments, the base 148 may be a part of larger device. For example, the base 148 may be the arm of a robotic apparatus, for example a multi-axis robot such as that commercially available under the trade designation UR5e (from Universal Robots A/S of Odense, Denmark). In still other embodiments, (not shown) a base may include a plate that is attachable to a separate apparatus, for example, attachable to an end effector of a separate apparatus.

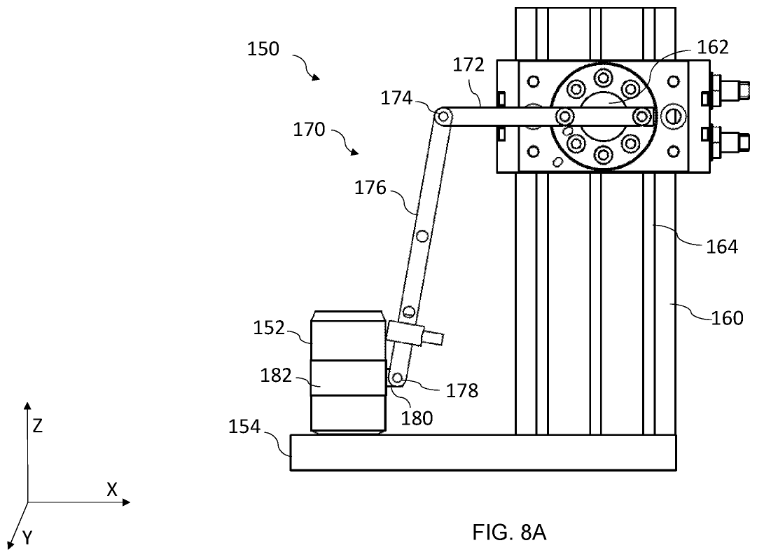

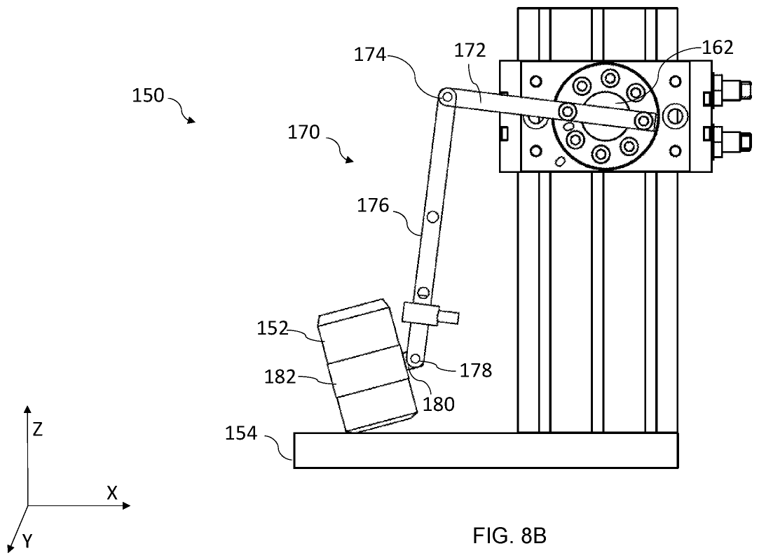

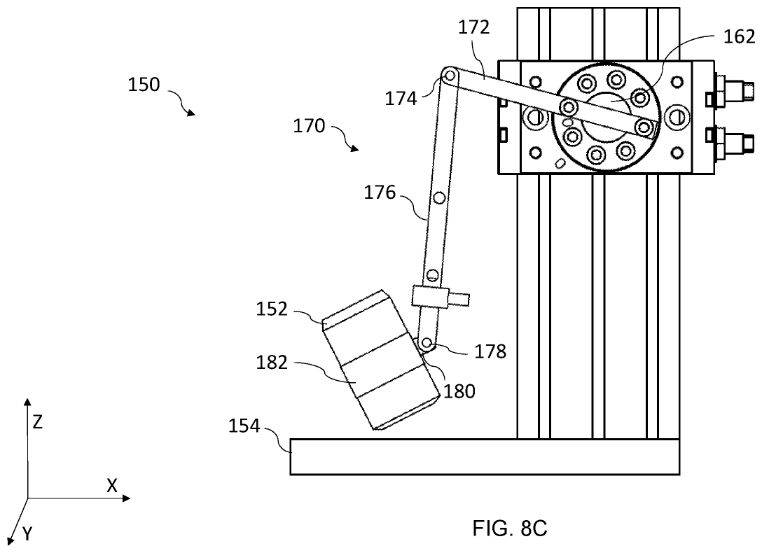

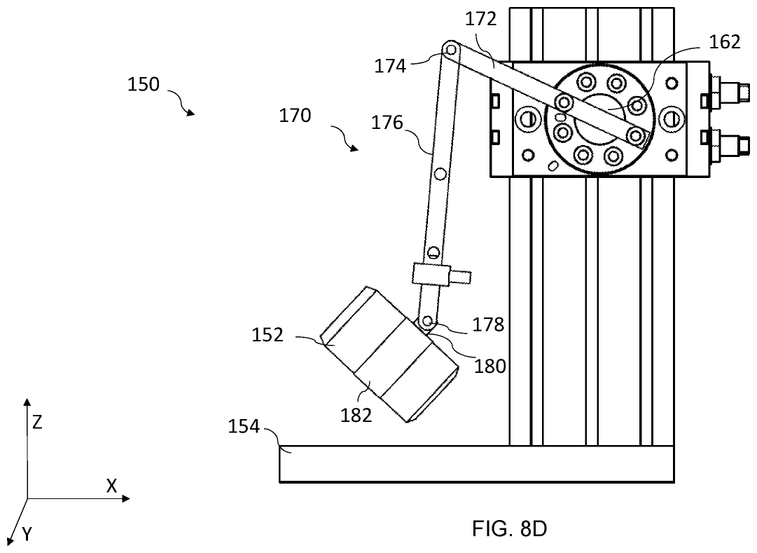

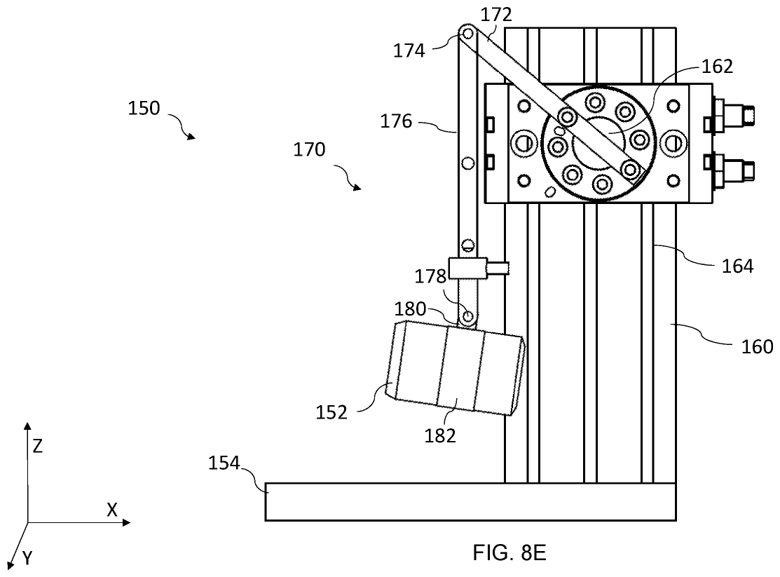

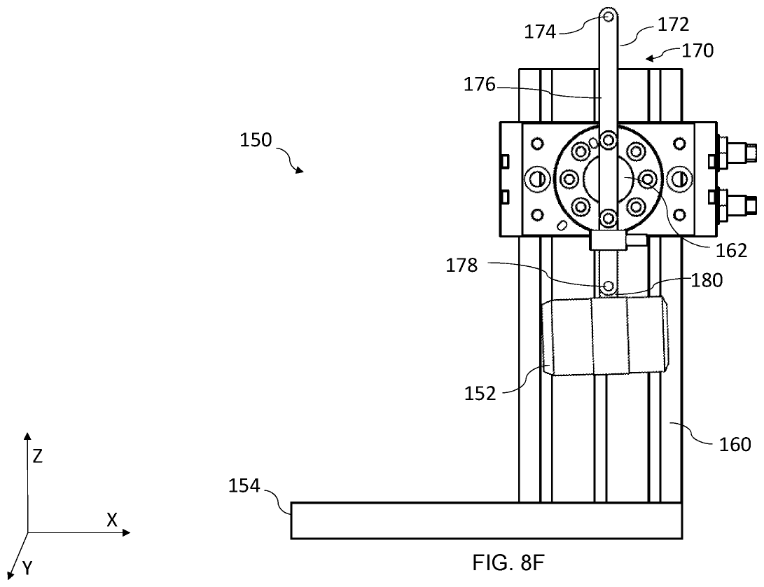

FIGS. 8A to 8F show an example motion sequence of a testing device 150 moving a test sample 152. In some embodiments, the motion sequence of the testing device 150 in FIGS. 8A to 8F can be carried out with the testing devices shown in FIGS. 1 to 3. The motion sequence shown in FIGS. 8A to 8F can be used to separate a portion of a packaged assembly (such as that shown in FIGS. 1 and 2) from the remaining portion of the packaged assembly. The testing device 150 can exhibit forces on the test sample 152 and move the test sample 152 in space. The testing device 150 can be used to exert forces on the test sample 152 such that the test sample undergoes a translational motion that more closely resembles the motion of a test sample being removed from a packaged assembly than just linear motion. The testing device 150 can be used to bring the testing sample 152 through one or more of linear motion, rotational motion, and circular motion with respect to the remaining portion of the packaged assembly. The testing device 150 can be used to measure forces exerted on the test sample 152 as it is removed from the packaging configuration.

As shown in FIG. 8A, the testing device 150 and the test sample 152 can be positioned on a platform 154. The testing device 150 includes a base 160 having a slide 164 and a first joint 162; and an arm 170 having a first branch, 172, a second joint 174, a second branch 176, a third joint 178, a third branch 180, and an attachment mechanism 182. The attachment mechanism 182 shown in FIGS. 8A to 8F is shaped as a ring, clamp, or claw positioned around the circumference of the test sample 152 and defining a longitudinal axis corresponding to a central axis of the test sample 152. Each of the first joint 162, second joint 174 and third joint 178 can rotate independently about an axis defined perpendicular to the X-Z plane. The test sample 152 can rotate such that a longitudinal axis of the test sample 152 rotates parallel to the X-Z plane.

In some embodiments, a portion of a packaged assembly can be held in place by a retention device (such as that shown in FIG. 6) in a fixed position on the platform 154. The testing device 150 can be positioned a suitable distance from the retention device. The testing device 150 can be adjusted such that the first joint 162 is a suitable height above the platform 154, such as by moving the slide 164 up or down. The testing device 150 is shown with the base 160 positioned a suitable distance from the testing sample 152 such that the arm 170 can extend from the base 160 to the testing sample 152 and the attachment mechanism 182 can be attached to a testing sample 152 positioned on the platform 154.

FIG. 8B shows the testing device 150 shown in FIG. 8A at a position further along the sequence. As shown the first joint 162 can rotate about its axis and rotate the first branch 172 along the X-Z plane. In some embodiments, a motor can be used to drive rotation of the first joint 162. As shown, the first branch 172 can rotate with the first joint 162 and lift the second branch 176. The first branch 172 can lift the second joint 174 away from the platform 154 which lifts the second branch 176. As the first branch 172 lifts the second branch 176, the second branch 176 can rotate about an axis defined through the second joint 174. As the first joint 162 rotates the first branch with respect to the base 160, the second branch 176 rotates with respect to the first branch 172.

As the second branch 176 moves with respect to the platform 154, it can move the third joint 178, which moves the third branch 180. The second branch 176 can lift the third joint 178 away from the platform 154 which lifts the third branch 180. The third branch 180 can move away from the platform 154 and move the attachment mechanism 182, which in turn moves the test sample 152.

The third joint 178 can rotate with respect to the second branch 176 and the third branch 180 can rotate with respect to the second branch 176. With the third branch 180 attached to the third joint 178 on one side, as the third joint 178 rotates, the third branch 180 rotates. As the third branch 180 rotates, the attachment mechanism 182 rotates, which rotates the test sample 152.

In combination, as the first joint 162 rotates, the attachment mechanism 182 can lift the test sample 152 away from the platform 154 and cause the test sample 152 to rotate. In some embodiments, the second joint 174 can freely rotate. That is, the second joint 174 can be free of a driving motor and rotation of the second joint 174 can be driven by the first branch 172 lifting the second branch 176. For example, if the second joint 174 does not include a mechanism to prevent it from freely rotating, the effect of the first branch 172 rotating, and the effect of gravity on the test sample 152 can cause the second joint 174 to rotate. In some embodiments, rotation of the second joint 174 causes translational motion of the testing sample 152 with respect to the platform 154. In some embodiments, the third joint 178 can freely rotate. Rotation of the third joint can be driven by the first branch 172 lifting the second branch 176, which lifts the third branch 180. In some embodiments, rotation of the third joint 178 causes rotational motion of the testing sample 152 with respect to the platform 154.

FIG. 8C shows the testing device 150 shown in FIG. 8B at a subsequent stage along the sequence. As shown, the first branch 172 has rotated further in the clockwise direction from FIG. 8B, and the first joint 162 has lifted the second branch 176 further from the platform 154. The second branch 176 can rotate further about the second joint 174 with respect to the first branch 172.

As the second branch 176 lifts the third joint 178 away from the platform 154, the third joint 178 lifts the third branch 180. The third branch 180 can move away from the platform 154 and move the attachment mechanism 182, which carries the test sample 152 off the platform 154. As the third branch 180 continues to rotate, the attachment mechanism 182 rotates which rotates the test sample 152.

FIG. 8D shows the testing device 150 shown in FIG. 8C at a subsequent stage along the sequence. As shown, the first joint 162 is rotated further in the clockwise direction and the first branch 172 has rotated with respect to the platform, bringing the second joint 174, second branch 176, third joint 178, and third branch 180 further from the platform 154. In some embodiments, the first joint 162 is the only joint having a driving mechanism associated with it. That is, the second joint 174 and the third joint 178 can be configured to freely rotate such that rotation of the second and third joints 174, 178 are driven only by movement of the first branch 172.

The attachment mechanism 182, has brought the test sample 152 off the platform 154, and the test sample 152 has further rotated in the counterclockwise direction about the third joint 178. The test sample 152 can trace a circular path as it moves away from the platform 154 and a rotational path as it rotates with respect to the platform 154.

As the test sample 152 is lifted from the platform 154, if a section of the test sample 152 is attached to the remaining portion of the packaged assembly, the packaging configuration can hold on to the test sample 152. The combination of the first joint 162 rotating and the first branch 172 pulling the second and third branch 176, 180 applies strain on the arm 170. The strain on the arm 170 can be measured and recorded by a load cell or strain gauge such as that shown in FIGS. 5A and 5B. The position of the arm 170 can also be recorded with a motion capture device and positions of the arm 170.

FIG. 8E shows the testing device 150 shown in FIG. 8D at a subsequent stage along the sequence. As shown, first joint 162 is rotated further in the clockwise direction and the first branch 172 has lifted the second joint 174, second branch 176, third joint 178, and third branch 180 further from the platform 154. If the second joint 174 does not include a mechanism to prevent it from freely rotating, the effect of the first branch 172 rotating clockwise, and the effect of gravity on the test sample 152 can cause the second joint 174 to rotate in the counterclockwise direction. As the second joint 174 rotates in the counterclockwise direction, the test sample 152 is brought closer to base 160 compared to its starting position on the platform. If the third joint 178 does not include a mechanism to prevent it from freely rotating, the effect of the stresses applied by gravity on the test sample 152, any remaining attachment to the testing assembly, and the location of the center of mass of the test sample 152 in relation to the attachment mechanism 182 can cause the test sample 152 to rotate.

Typically, as the test sample 152 moves away from the remainder of the packaged assembly, which is held in place, the test sample 152 separates from the packaged assembly and the packaging configuration holding the test sample breaks. The strain on the arm 170 before and after the break can be recorded. The strain on the arm 170 can be measured and recorded by a load cell or strain gauge. The position of the arm 170 can also be recorded with a motion capture device to determine at what position the breakage occurs.

The stresses exerted on the arm 170 as the attachment mechanism 182 moves the test sample 152 off the platform 154, rotates it, and separates it from the packaged assembly can be recorded. The motion of the test sample 152 can also be recorded to determine the path the test sample 152 traces as it moves away from the platform 154.

FIG. 8F shows the testing device 150 of FIG. 8E at a position further along the sequence. In some embodiments, the position of the arm 170 in FIG. 8F can be the final position of the testing device 150 after a test. The test sample 152 can be fully removed from the packaged assembly at this stage. The first joint 162 has rotated the first branch 172 such that the second joint 174 has rotated. If the second joint 174 has no braking or driving mechanism, it can freely rotate, bringing the second branch 176 and the third joint 178 proximate the base 160. The third branch 180 is rotated around the third joint 178 and the test sample 152 has rotated around the third joint 178 in a counterclockwise direction from the position shown in FIG. 8E.

In some embodiments, the motion of the components shown in sequence from FIGS. 8A to 8F can be analyzed to determine for example, the position of the test sample 152 in relation to the stresses placed on the arm 150. Tracing the path of the test sample from FIGS. 8A through 8F, the center of mass of the test sample 152 can be approximated with the third branch 180. The test sample 152 undergoes rotational and translational motion with respect to the platform 154. The test sample 152 undergoes circular motion with respect to a fixed point, such as the platform 154. That is, tracing the path that the center of mass of the test sample 152 takes as it moves from the platform, the center of mass can be shown to undergo circular motion with respect to the platform 154 while the test sample 152 rotates such that its orientation changes with respect to the platform 154.

By tracing a single point on the testing sample, translational motion such as linear or circular motion, can be plotted. For example, using just the starting and ending positions of the test sample in FIGS. 8A and 8F, the change in position of the center of mass of test sample 152 at the two stages in the test sequence can be plotted with a straight line. Plotting the position of the center of mass of the test sample 152 at each stage of the sequence in FIGS. 8A through 8F, the test sample 152 can be shown to trace a circular path from its starting to ending position. Using two fixed positions of the testing sample 152 at each stage of the sequence in FIGS. 8A through 8F, rotational motion of the test sample 152 can also be plotted. In some embodiments, it can be shown that the test sample 152 rotates about an axis defined by the third joint 178. The position and path of the test sample 152 in relation to the stresses placed on the arm 170 can be plotted on a graph. In some embodiments, a multijointed apparatus can be used to carry a testing sample through a more complex travel path than linear motion, for example a multijointed apparatus can carry a testing sample through parabolic path, elliptical path, or combination thereof

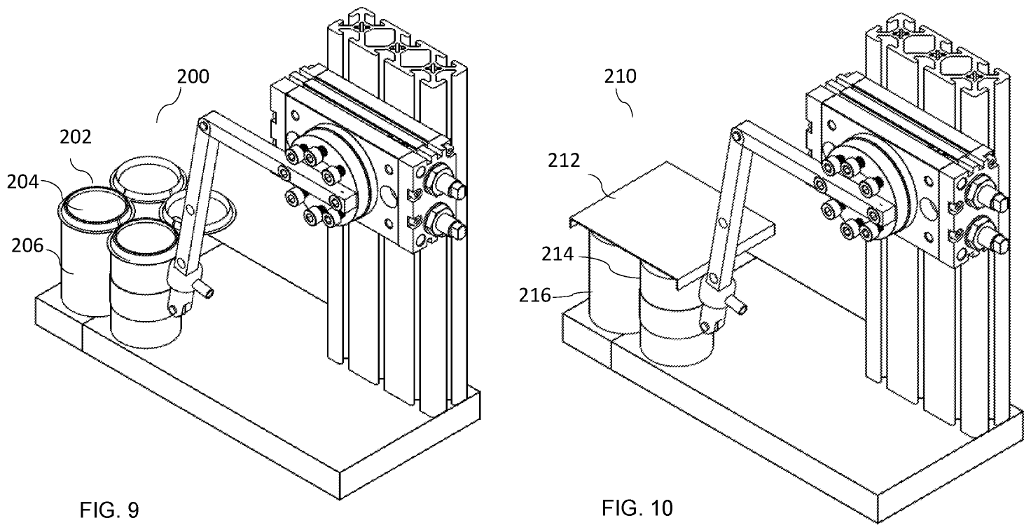

FIGS. 9 to 15C show various non-limiting aspects of packaging configurations that can be tested using the devices and processes disclosed herein. Such packaging configurations may be used to hold together a plurality of items, for example cans, bottles, boxes, cartons, or packs, to form a packaged assembly. Packaging configurations in addition to those described herein, such as having alternative shapes, sizes, or weights can also be tested using the devices and processed disclosed herein.

FIG. 9 shows a packaging configuration 200 that can be tested. The packaging configuration 200 in FIG. 9 includes a ring 202 defining an opening 204. The opening 204 can be sized and shaped to receive a portion of an item 206 such as a top of a can or bottle. The items to be packaged can be attached to opening 204 through a shaped fit, such as a shaped fit around the top of the cans or bottles to retain them. The packaging configuration can include a handle. One example of a commercially available packaging configuration is that available under the trade designation HI-CONE (from ITW, of Itasca, Illinois, USA). Removing the item 206 from the packaging configuration 200 can include separating the item 206 from the ring 202 by breaking the ring 202. Removing the item 206 from the packaging configuration 200 can include pulling the item 206 through the opening 204. An example motion that a consumer might use to separate one item may be to hold the item 206 and pull it in a radial direction from the central axis of the ring 202 to break the ring 202. Another example motion to separate the item 206 could be to pull in a direction parallel to the central axis of the ring 202 to pull the item through the opening 204. Another example motion may be rotating the item 206 in relation to the packaging configuration 200. Another example motion may be a combination: rotating the item 206 while also pulling it away from the packaging configuration 200. Depending on the strength and dimensions of the material used to from the ring 202, the ring 202 may break before the consumer is able to pull the item 206 out of the opening 204. The ring 202 may be formed of a flexible material such as flexible plastic, cardboard, or rubber. Alternatively, the ring 202 may be formed of a rigid material such as rigid plastic, cardboard, wood, bamboo, metal, or plexiglass.

FIG. 10 shows another example packaging configuration 210 that can be tested. The packaging configuration 210 in FIG. 10 includes a first portion 212 that can be positioned over the top of the items to be packaged, such as a plurality of cans or bottles. In some embodiments, the packaging configuration can have a second component 214 that can be adhesive positioned between the items to be packaged. The items to be packaged can be attached to one or both of the first portion 212 and the second component 214. For example, an item 216 can be attached to the first portion 212 and to the remaining items of the packaged assembly through the second component 214. The items to be packaged can be attached to the first portion 212 through a shaped fit, such as a shaped fit around the top of the cans or bottles to retain them. The first portion 212 can include a handle. Removing an item 216 from the packaging configuration can include separating the item 216 from the first portion 212 by breaking the adhesive, if present, and/or removing the item 216 from the shaped fit by pulling the item 216 out of the shaped fit. Removing the item 216 from the packaging configuration can also include separating the item 216 from the second component 214, or even other items in the packaging configuration by breaking the adhesive. An example motion that a consumer might use to separate the item 216 may be to hold the item 216 and pull away from the first portion 212. Another example motion could be to pull laterally, or away from the second component 214 and from the remaining items. Another example motion may be rotating the item in relation to the packaging configuration 210. Another example motion may be a combination, rotating the item 216 to be separated while also pulling the item 216 away from the packaging configuration 210.

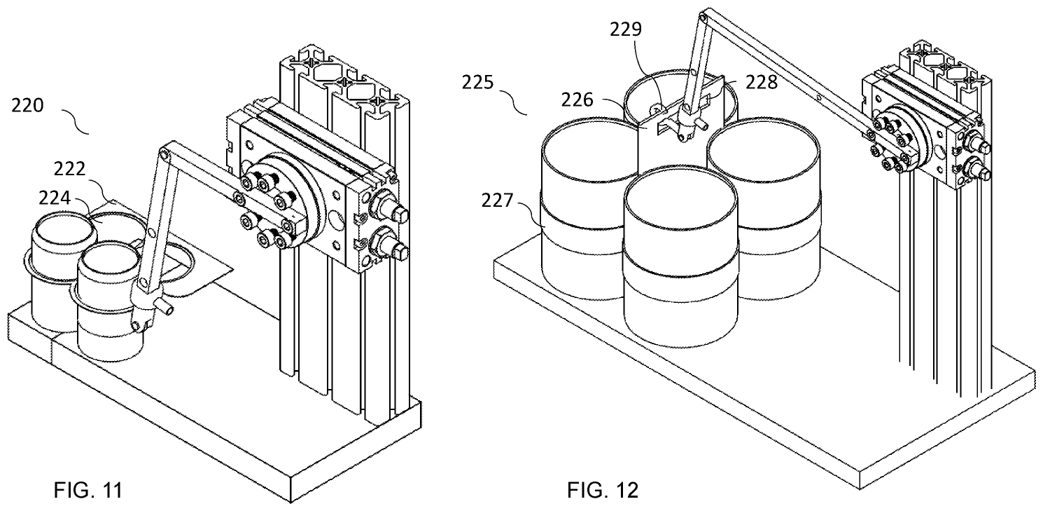

FIG. 11 shows another packaging configuration 220 that can be tested. The packaging configuration 220 in FIG. 11 includes a planar portion 222 defining at least one opening 224. As shown, the packaging configuration 200 is positioned about mid-way along the length of a group of cans. Removing an item from the packaging configuration 220 can include any of breaking the planar portion 222 or pulling the item through the opening 224. An example motion that a consumer might use to separate one item might be to pull it laterally from the planar portion 222 to break the planar portion 222. Another example motion could be to pull the item downward or upward through the opening 224. Another example motion might be rotating the item. Another example motion may be a combination of rotational motion and translational motion. Depending on the strength and dimensions of the material used, the planar portion 222 might break before the consumer is able to pull the item out of the opening 224.

FIG. 12 shows a packaging configuration 225 that can be tested. As shown in FIG. 12, the packaging configuration 225 forms a packaged assembly that includes large capacity cans, such as those made of steel or aluminum. The packaged assembly can include steel cans, such as those having a 794 gram (28 oz) capacity (for example suitable for containing baked beans, such as those available under the trade designation BUSH'S BEST, from the Bush Brothers and Co., of Knoxville, Tennessee, U.S.A.) The packaging configuration 225 includes a planar portion 226 attached to one or more retention portions 227 defining openings. As shown, the retention portions 227 of the packaging configuration 225 are positioned about mid-way along the length of a group of cans. Removing an item from the packaging configuration 225 can include any of breaking the planar portion 226 or pulling the item through the retention portions 227. An example motion that a consumer might use to separate one item may be to pull it through the opening in the retention portions 227 or even break retention portions 227. Another example motion may be rotating the item. FIG. 12 also shows an opening 228 defined in the planar portion 226 of the packaging configuration 225. The opening 228 may be suitable as a handle. Also shown in FIG. 12 is an attachment mechanism 229 that may be suitable for testing the packaging configuration 225. The attachment mechanism 229 may be any of the attachment mechanisms described in FIGS. 4A to 4F, such as the hook 105. As shown, the attachment mechanism 229 can be connected to the packaging configuration 225 and used to test the performance characteristics.

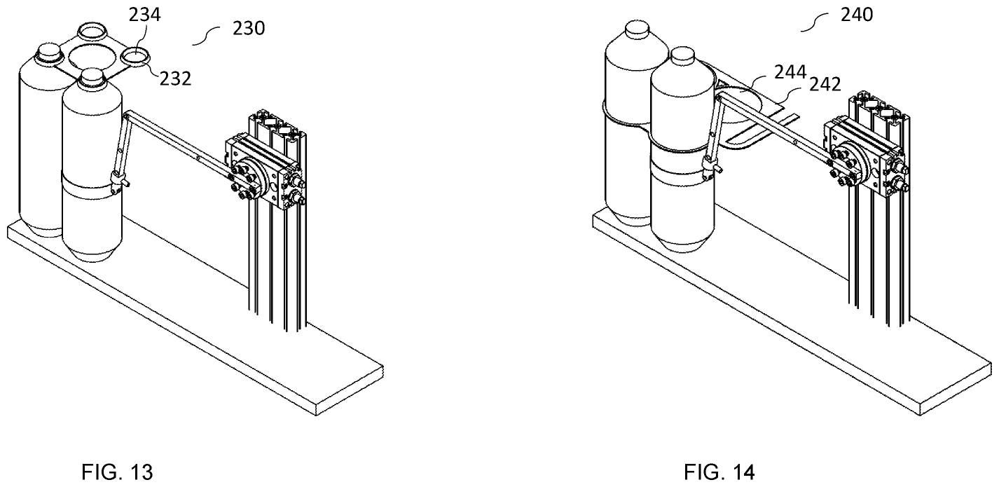

FIG. 13 shows a packaging configuration 230 that can be tested. The packaging configuration 230 in FIG. 13 includes a ring 232 defining an opening 234. The opening 234 can be sized and shaped to receive a portion of an item. The item to be packaged can be attached to the opening 234 through a shaped fit. The packaging configuration 230 can include a handle. One example of a commercially available packaging configuration may be any of those available under the trade designations RINGCYCLES or HI-CONE (from ITW, of Itasca, Illinois, U.S.A.). Removing an item from the packaging configuration 230 can include by breaking the ring 232. Removing an item can include pulling the item through the opening 234. An example motion that a consumer might use to separate one item may be to pull it linearly through the ring 232 to break it. Another example motion could be to pull in a direction away from the ring 232 to pull it through the opening 234. Another example motion may be rotating the item in relation to the packaging configuration 230. Another example motion may be a combination of rotating the item while pulling it away from the packaging configuration 230. The ring 232 may be formed of a flexible material such as flexible plastic, cardboard, or rubber. Alternatively, the ring 232 may be formed of a rigid material such as rigid plastic, cardboard, wood, bamboo, metal, or plexiglass.

FIG. 14 shows a packaging configuration 240 that can be tested. The packaging configuration 240 in FIG. 14 includes a planar portion 242 defining an opening 244. As shown, the packaging configuration 240 is positioned about mid-way along the length of items to be packaged, shown in FIG. 14 as a plurality of bottles. Removing an item from the packaging configuration 240 can include any of breaking the planar portion 242 or pulling the item through the opening 244. An example motion that a consumer might use to separate one item may be to pull it laterally through the planar portion 242 to break the planar portion 242. Another example motion could be to pull the item in a downward direction away from the opening 244 to cause the item to pass down through the opening 244. Another example motion may be rotating the item. Another example motion may involve a combination of rotational motion and translational motion. Depending on the strength and dimensions of the material used for the planar portion 242, the planar portion 242 might break before the consumer is able to pull the item out of the opening 244.

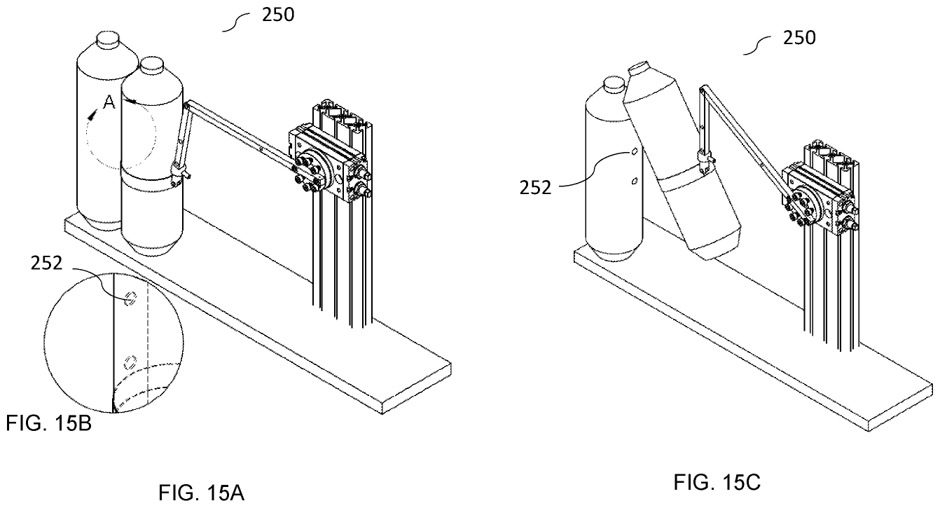

FIGS. 15A, 15B and 15C show a packaging configuration 250 that can be tested. FIG. 15B shows a packaging material 252 that is hidden from view in FIG. 15A, in the area located within the insert shown by the arrow A in FIG. 15A. As shown in FIG. 15B, the packaging material 252 can be formed into one or more areas positioned along a side of an item to be packaged. In some embodiments, the packaging material 252 can be any of an adhesive composition or an adhesive tape that is positioned between separate items and that holds two or more items together. FIG. 15C shows another view of the packaging material 252 of FIGS. 15A and 15B, with the packaging material 252 visible as the packaged items are separated from each other. In some embodiments, an example of a commercially available adhesive that might be suitable as the packaging material 252 may be a hot melt adhesive available from H.B. Fuller Company (of St. Paul, Minn., U.S.A.)

The testing devices and processes disclosed herein are suitable for removing a first item of a packaged assembly from the remaining item or items of the packaged assembly. The testing device can be used to measure the stresses applied to various items (e.g. containers such as cans, bottles, cartons, etc.) as the user separates one container from the remaining container or containers. The testing device can measure the failure of the packaging configuration to contain the items as a consumer separates one container from the remaining container or containers.

The testing device can measure the failure of the packaging material used to contain the items in a manner that approximates the action a consumer uses to separate one item from the remaining items of a packaged assembly. The testing device can provide a more accurate representation of how a consumer handles an item as the item is separated from the packaged assembly compared to a test that only measures forces applied in a linear direction. The testing device can be used to conduct a desired uniform test multiple times in a repeatable manner. For example, the testing device can test the performance of packaging material as forces are exerted on the packaging configuration by movement of the item in multiple directions, including such forces that result from translational motion, rotational motion, circular motion, and combinations thereof.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

### EXAMPLES

The following non-limiting examples are included to further illustrate various embodiments of the instant disclosure and do not limit the scope of the instant disclosure.

### Test Device

The force experienced by a test sample is measured by removing the test sample from a packaged assembly using the test device of FIG. 3. The test device includes a rigid circular ring attachment device, a data acquisition timer, an in-line tension/compression load cell, and a motor for providing rotational motion to the first joint of the test device. The second and third joints of the test device have no drive motor.

### Testing Process

To generate test data for each kind of packaged assembly, one item of each of a plurality of items is selected as the test sample. The remaining items of the packaged assembly are secured by a retention device so that they remain stationary during the test process.

The attachment mechanism is placed around the test sample such that the axis of the third joint of the test device is positioned about a third of the distance down from the top of the test sample. The test device is set so that the first branch of the test device is substantially parallel to the surface that the test sample is on (e.g. 0° with respect to the X-Y plane). The second branch of the test device is set to 250° relative to the first branch of the test device. The load cell is zeroed (set to 0.0).

The force experienced by the test sample is measured by the in-line tension/compression load cell, which is positioned along the second branch of the test device. The data acquisition timer (a programmable timing circuit) and the rotational drive motor are engaged for a period of 500 milliseconds (ms). Data, including time and force, as well as the positions of the test sample and test device are recorded at the appropriate frequency. The test process is recorded with a motion camera.

As the first joint of the test device is rotated, the load cell voltage changes relative to the force exerted on the load cell. This change is recorded throughout the test process at a rate of 100 Hz to five (5) KHz. The load cell data is stored and associated with the time interval of the test at that data point.

### Packaged Assemblies A-E

The packaged assemblies that were tested included a plurality of aluminum cans. Cans of the beverage commercially available under the trade designation DIET COKE (from Coca-Cola Company of Atlanta, Georgia, U.S.A.) and ZEVIA (from Zevia of Los Angeles, California, U.S.A.) were used. Each can contained a carbonated beverage and had the following properties: a diameter of 66 mm, height of 123 mm, volumetric capacity of 355 ml, and mass of 375 grams.

One group of DIET-COKE cans having no packaging configuration holding the cans together (Test Sample A) was used to generate baseline test data. Test samples of DIET COKE cans held together with (B) a packaging configuration having a single dot of adhesive material between adjacent cans, (C) a packaging configuration having two dots of adhesive between adjacent cans (as generally shown on FIG. 15C), (D) a carton clipped top packaging configuration (generally shown on FIG. 10), and (E) with a HI-CONE packaging configuration (from ITW) (generally shown on FIG. 9) were prepared. The packaging configuration having a single dot of adhesive material between adjacent cans (Test Sample B), the packaging configuration having two dots of adhesive material between adjacent cans (Test Sample C), and the carton clipped top packaging configuration (Test Sample D) each were prepared with an 8-pack configuration arranged with the cans in two rows of four cans each. The packaging configuration with the HI-CONE packaging configuration (Test Sample E) was prepared with six cans of ZEVIA, arranged with the cans in two rows of three cans each.

### Data Analysis

Test data was obtained for each of the Test Samples A to E by testing the samples according to the Test Process set forth above. The data obtained by the process was then exported to a program for analysis.

The analysis was conducted with the following parameters. As the time of the test process elapsed from time 0 ms to time 500 ms, the first branch of the test device was moved from 0° (parallel to the surface test sample was on) to 90° (perpendicular to the X-Y plane). When the first branch completed this rotation, the process was complete. The entire process occurred in less than 500 ms. The data was then plotted to form graphs for data comparison. The first data set included the product of pounds force (lbs_{f}) versus time in milliseconds. The peak force experienced by the test sample was multiplied by time to give the impulse (in units of lbs_{f}*s) at peak force. The data of impulse (i.e. lbs_{f}*s) versus the degree of rotation is plotted with 0° at the test device starting position and 90° at the final position. This could also be expressed as π/2 radians. These plotted data were then compared with those of other test samples.

The relative position of the various components of the test device were correlated to an associated time during the test process. For example, if the first joint moved from 0° to 90° in 0.354 seconds, the positional data would be 0.000 seconds at 0° and 0.354 seconds at 90°. Once the first branch reached 90° with respect to the surface from which the test article started (i.e. when the first branch reached an orientation parallel to the length of the base), any data gathered after that point was not plotted. The values of time and force were then multiplied to provide the value for the impulse. The impulse values were then graphed so that the position of the first branch (in degrees from 0° to 90°) corresponds to the X axis, and the value of the impulse corresponded to the Y axis.

### Force Versus Time Plots

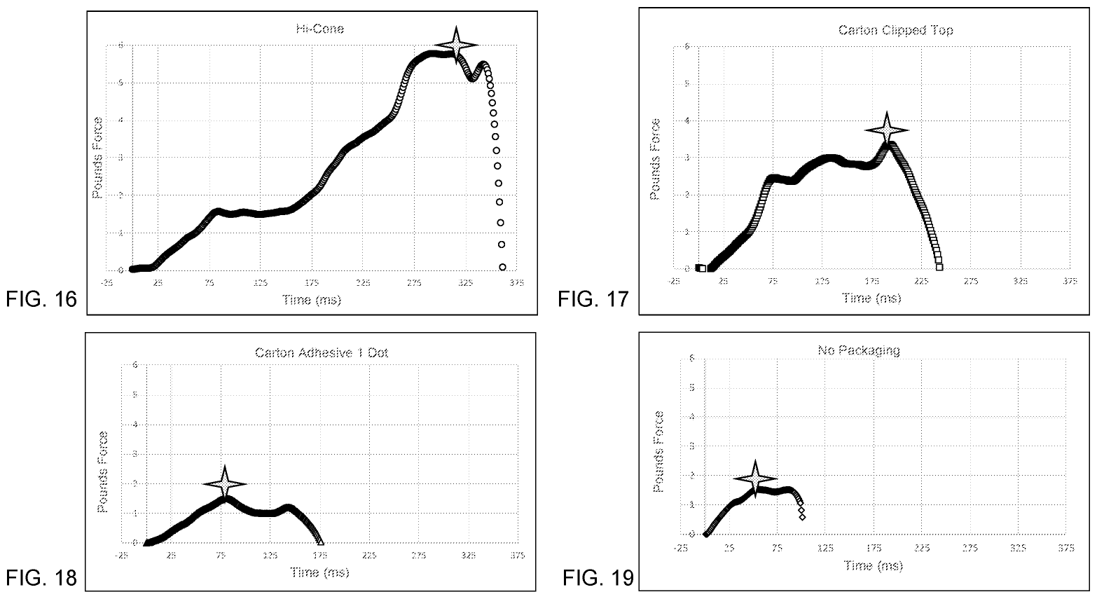

FIGS. 16 to 19 shows plots of the force (Y axis) experienced by the test sample (as measured with a load cell on the second branch) over time (X axis) during the test process. The star shown on each plot designates the moment at which the test sample was fully separated from the remaining portion of the packaging configuration. For FIGS. 16, 17, and 18, this moment generally correlates to the point when the portion of the packaging configuration holding the test sample together breaks, and the test sample is no longer connected to the remaining portion of the packaged assembly. FIG. 16 shows the data gathered from a test of a Test Sample E (HI-CONE packaging configuration). FIG. 17 shows the data gathered from a test of Test Sample D (carton clipped top packaging configuration). FIG. 18 shows the data gathered from Test Sample B (single dot of adhesive material). FIG. 19 shows the data gathered from Test Sample A (no packaging configuration).

### Force and Impulse Plots

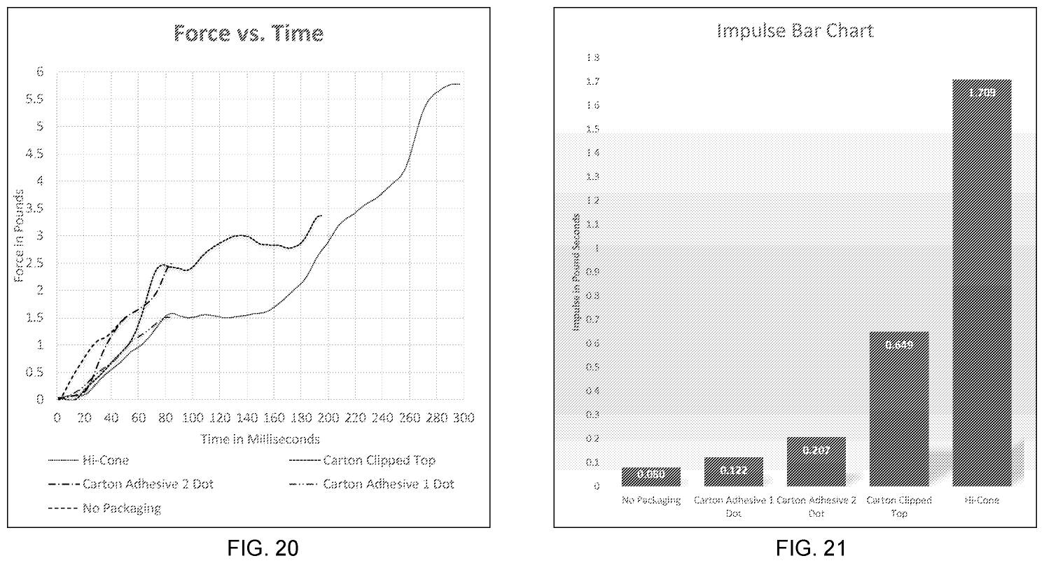

FIG. 20 is a plot showing force experienced by a test sample as it was separated from a packaged assembly with various packaging configurations. The X axis shows the time expired since the start of the test. The Y axis shows the force experienced by the test sample. The value of the force is shown by the line charts and has an individual legend showing each packaging configurations. The lines generated when plotting each of these tests show the force versus time for each packaging configuration respectively, and each line terminates at the peak force value. As shown, the data for Test Sample E (HI-CONE packaging configuration) corresponds to the longest line, the data for Test Sample D (carton clipped top packaging configuration) corresponds to the second longest line, the data for Test Sample C (two dots of adhesive material) corresponds to the third longest line, the data for Test Sample B (single dot of adhesive material) corresponds to the fourth longest line, and the data for Test Sample A (no packaging configuration) is the shortest line.

FIG. 21 is a graph showing the maximum impulse experienced by the test samples over the entire test plotted in FIG. 20. The bars on the chart reflect the total impulse value, which is calculated by multiplying the peak force by the time in seconds to reach the peak force. As shown, the HI-CONE data (Test Sample E) corresponds to the largest impulse, the carton clipped top (Test Sample D) the second largest, the configuration with two dots of carton adhesive (Test Sample C) is the third largest, the configuration with one dot of carton adhesive (Test Sample B) is the fourth largest, and the test sample with no packaging configuration (Test Sample A) is the shortest.

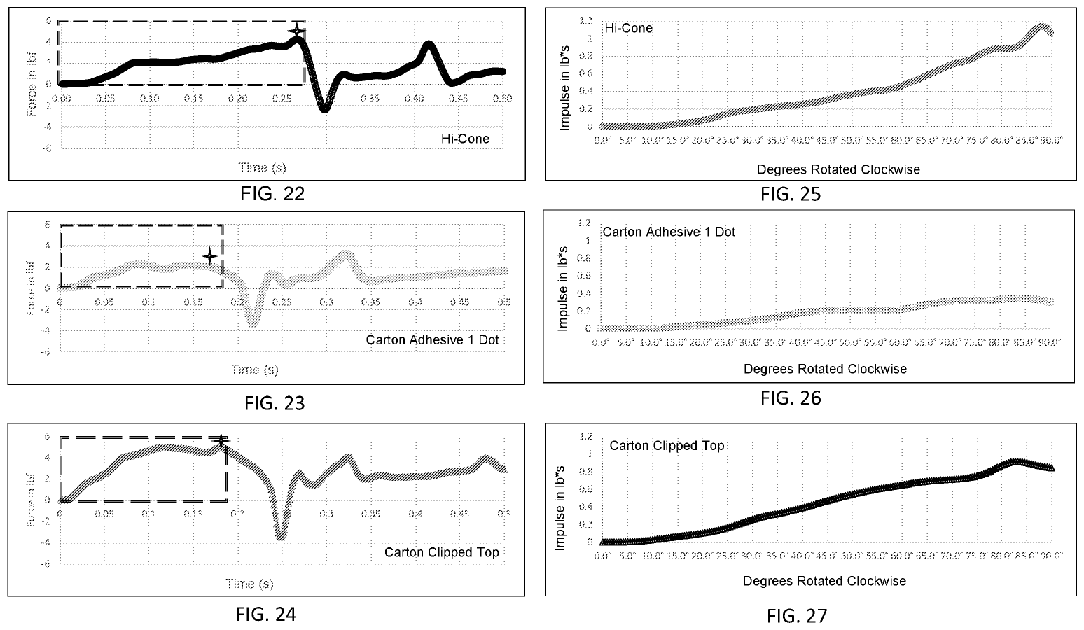

FIGS. 22 to 24 show plotted data of force versus time at points in the test process for example packaging configurations. FIG. 22 shows the measured values taken from a test of Test Sample E. FIG. 23 shows the measured values taken from a test of Test Sample B. FIG. 24 shows the measured values taken from a test of Test Sample D. The location along the plotted line in each graph shown by a star corresponds to the time at which the test sample separated from the rest of the packaged assembly.

FIGS. 25 to 27 show plotted data of impulse versus the rotational position of the first joint along a clockwise path. The starting position corresponds to the first joint in a starting position with the first branch generally parallel to the X-Y plane (i.e. about 0° rotation), which typically corresponds to the beginning of a test process when force is not being exerted on the test sample. Each plotted line ends when the first joint has been rotated to about a 90° angle from the starting angle (i.e. the first branch being generally parallel to the X-Y plane). FIG. 25 shows the measured values taken from a test of Test Sample E. FIG. 26 shows the measured values taken from a test of Test Sample B. FIG. 27 shows the measured values taken from a test of Test Sample D.

The inserted box shown by offset broken lines in each of FIGS. 22 to 24 corresponds to the degrees of rotation from 0° to 90° of the first branch of the arm of the test device during a test process and corresponds to the graph shown in the figure to the right. That is, the box in the plot shown in FIG. 22 corresponds to the window of time over the entire rotation shown in FIG. 25. The box in FIG. 23 corresponds to the window of time over the plot in FIG. 26. The box in FIG. 24 corresponds to the window of time in the plot in FIG. 27.

As described herein, the testing device and methods can be used to establish a direct comparison between multiple forms of packaging and measure various forces applied to multiple locations of the packaging, rather than just linear forces. The testing device and methods can be used to subject a test sample to a more complex motion compared to a test device that only subjects the test sample to linear motion. The testing device can be used to conduct a desired test multiple times in a repeatable manner. The testing device can be used to perform a repeatable test that allows a user to determine a suitable balance between providing enough strength to maintain the items as a packaged assembly while in transit and not providing too much strength that it is unnecessarily difficult for a consumer to separate items from the packaged assembly at the point of consumption. The testing device can be used to conduct a desired test of packaging configurations of any of cans, bottles, or cartons of, for example, household goods, industrial goods, cleaning supplies, food, or beverages.

The testing device can be used to test various packaging configurations to optimize parameters such as the shape, arrangement, thickness, kind of material, amount of material, surface chemistry of the item to be packaged, and location of the packaging configuration on the packaged items. The testing device can be used to perform quality control tests of packaging configurations.

1. A testing device comprising:
a base including a first joint; and
an arm having
a first branch connected to and pivotable about the first joint;
a second joint connected to the first branch;
a second branch connected to and pivotable about e second joint;
a third joint connected to the second branch; and
a third branch connected to and pivotable about the third joint, the third branch having an attachment mechanism,
the arm configured to pivot at he first joint in relation to the base along an X-Z plane, and
the first joint configured to drive movement of the arm through rotation of the first joint.

2. The testing device of claim 1, wherein the second joint and third joint are configured to rotate freely.

3. The testing device of claim wherein the first joint is configured to control movement of the arm along the X-Z plane through rotation about the first joint.

4. The testing device of claim 1, further including a motor configured to drive rotation of the first joint.

5. The testing device of claim 1, wherein the second branch is configured to rotate about the second joint in an orientation parallel to the X-Z plane.

6. The testing device of claim 1, wherein the third branch is configured to rotate about the third joint in an orientation parallel to the X-Z plane.

7. The testing device of claim 1, wherein the attachment mechanism is configured to retain a first portion of a test sample.

8. The testing device of claim 1, wherein the arm includes a stress measurement device. cm 9. The testing device of claim 1, further including at least one selected from the group of a load cell, a strain gauge, a transistor, a transducer, and a position indicator.

10. The testing device of claim 1, further including a retention device associated with and configured to retain a second portion of a test sample at a fixed distance from the base.

11. A testing device comprising:
a base defining a first end and a second end and a length defined along a direction perpendicular to an X-Y plane, the base having a first joint pivotable in an orientation parallel to an X-Z plane; and
an arm including
a first branch having a first end and a second end, the first branch connected to and pivotable about the first joint in an orientation parallel to the X-Z plane;
a second joint connected to the first branch;
a second branch having a first end and a second end, the second branch connected to and pivotable about the second joint in an orientation parallel to the X-Z plane;
a third joint connected to the second branch; and
a third branch having a first end and a second end, the third branch connected to and pivotable about the third joint in an orientation parallel to the X-Z plane, the second end of the third branch defining an attachment mechanism,
the first joint being configured to drive movement of the arm.

12. The testing device of claim 11, wherein the second joint and third joint are configured to rotate freely.

13. The testing device of claim 11, wherein the first joint is configured to control movement of the arm along the X-Z plane direction through rotation of the first joint.

14. The testing device of claim 11, further including a retention device configured to retain a second portion of a test sample at a fixed distance from the base.

15. A testing device comprising:
a base: and
an arm including
a first branch pivotally connected with the base;
a second branch freely pivotally connected with the first branch;
a third branch freely pivotally connected with the second branch and including an attachment device,
the base including a driving mechanism configured to rotate the first branch.

16. The testing device of claim 15, wherein the drive mechanism configured to the drive rotation of the first branch in relation to the base, the second branch is configured to rotate freely in relation to the first branch, and the third branch is configured to rotate freely in relation to the second branch.

17. The testing device of claim 15, wherein the third branch is configured to freely rotate about the third joint in an orientation parallel to the X-Z plane.

18. The testing device of claim 15, wherein the attachment device is configured to retain a first portion of a test sample.

19. The testing device of claim 15, further including a retention device configured to retain a second portion of a test sample at a fixed distance from the base.

20. The testing device of claim 15, further including at least one selected from the group of a load cell, a strain gauge, a transistor, a transducer, and a position indicator.
